(19) United States
(12) Patent Application Publication
(10) Pub. No.: US 2025/0183665 A1
(43) Pub. Date: Jun. 5, 2025

(54) SYSTEMS AND METHODS FOR BALANCING GRID VOLTAGE USING REAL POWER TRANSFER

(71) Applicant: EcoJoule Energy Pty Ltd, Loganholme (AU)

(72) Inventors: Mihai Ciobotaru, Brisbane (AU); Michael Wishart, Brisbane (AU)

(21) Appl. No.: 19/052,409

(22) Filed: Feb. 13, 2025

Related U.S. Application Data
(63) Continuation of application No. PCT/AU2023/050775, filed on Aug. 16, 2023.
(60) Provisional application No. 63/371,696, filed on Aug. 17, 2022.

(51) Int. Cl. H02J 3/16; H02J 3/26

(52) U.S. Cl. CPC H02J 3/16; H02J 3/26; H02J 2203/10; H02J 2300/24

(57) ABSTRACT

Disclosed is a method for voltage balancing. The method comprises (a) calculating an average voltage value from voltages of first and second phases of the multiphase grid system. The method also comprises (b) determining at least (1) a first voltage difference and (2) a second voltage difference. The method also comprises (c) producing at least (1) a first real current reference based on the first voltage difference and (2) a second real current reference based on the second voltage difference. The method also comprises (d) generating at least (1) a first alternating current (AC) voltage reference and (2) a second AC voltage reference. The method also comprises (e) modulating the first AC voltage reference and the second AC voltage reference to generate an input for a voltage source converter. The method also comprises (f) using at least the modulated input to provide real current to the multiphase grid system.

### CROSS-REFERENCE TO RELATED APPLICATIONS

This application is a continuation of International Application No. PCT/AU2023/050775, filed Aug. 16, 2023, which claims the benefit of U.S. Provisional Application No. 63/371,696, filed Aug. 17, 2022, each of which is incorporated by reference herein in its entirety.

### BACKGROUND

On long low-voltage (LV) distribution networks, voltage unbalance is a particular concern. Voltage unbalance may be caused by unbalanced loads or power generation caused by most houses each being connected to single-phase power. Despite efforts to balance three-phase loads or local power generators (e.g., photovoltaic (PV) inverters) by connecting individual phases consecutively to houses, distribution lines may remain unbalanced most of the time.

### SUMMARY

There is a need for a system that effectively reduces voltage unbalance without requiring the use of energy storage (e.g., batteries). The disclosed system may transfer active (or real) power between individual phases from a multi-phase grid system (e.g., three-phase, four-wire system). The system may implement this power transfer between phases using a static synchronous compensator (STATCOM).

In an aspect, disclosed are methods for voltage balancing in a multiphase grid system. A method comprises (a) calculating an average voltage value from voltages of a first phase and a second phase of the multiphase grid system. The method also comprises (b) determining at least (1) a first voltage difference between the average voltage value and the voltage of the first phase and (2) a second voltage difference between the average voltage value and the voltage of the second phase. The method also comprises (c) producing at least (1) a first real current reference based at least in part on the first voltage difference and (2) a second real current reference based at least in part on the second voltage difference. The method also comprises (d) generating at least (1) a first alternating current (AC) voltage reference based at least in part on the first real current reference and (2) a second AC voltage reference based at least in part on the second real current reference. The method also comprises (e) modulating the first AC voltage reference and the second AC voltage reference to generate an input to a voltage source converter. The method also comprises (f) using the voltage source converter to provide a real current to the multiphase grid system.

In some embodiments, in (f) the real current is provided to the multiphase grid system via a static synchronous compensator (STATCOM).

In some embodiments, (c) further comprises generating an equilibrium level of the first real current reference or the second real current reference.

In some embodiments, the generating comprises (i) augmenting the first real current reference with a portion of the second real current reference or (ii) augmenting the second real current reference with a portion of the first real current reference, based at least on the equilibrium level.

In some embodiments, the equilibrium level comprises a sum of the first real current reference and the second real current reference.

In some embodiments, the equilibrium level comprises a level of about zero.

In some embodiments, the first real current is negative if the voltage of the first phase is greater than the average value or positive if the voltage of the first phase is less than the average value.

In some embodiments, the second real current is negative if the voltage of the second phase is greater than the average value or positive if the voltage of the second phase is less than the average value.

In some embodiments, generating the first AC voltage reference and the second AC voltage reference further comprises summing the first real current reference and the second real current reference with an output current reference from a direct current (DC) voltage controller.

In some embodiments, generating the first AC voltage reference and the second AC voltage reference further comprises using a droop controller to produce a first reactive current reference and a second reactive current reference.

In some embodiments, the droop controller is configured to provide (1) individual droop control or (2) global droop control, wherein, for (1) the individual droop control, the first reactive current reference is based at least in part on the voltage of the first phase and the second reactive current reference is based at least in part on the voltage of the second phase, and wherein for (2) the global droop control, the first reactive current reference and the second reactive current reference are based at least in part on the average voltage value.

In some embodiments, using the droop controller further comprises saturating the first reactive current reference and the second reactive current reference based at least in part on a current rating of the voltage source converter, the first real current reference, and the second real current reference.

In some embodiments, (a) comprises dividing the multiphase grid system into at least the first phase, the second phase and a third phase.

In some embodiments, the multiphase grid system is a four-wire system.

In some embodiments, the modulating the first AC voltage reference and the second AC voltage reference is performed using sine pulse width modulation (PWM).

In some embodiments, calculating the average voltage value from the voltages of the first phase and the second phase comprises (i) producing (1) a first individual estimate of the voltage of the first phase and (2) a second individual estimate the voltage of the second phase; and (ii) calculating a mean of (1) the first individual estimate and (2) the second individual estimate.

In an aspect, disclosed are systems for voltage balancing in a multiphase grid system. A system comprises one or more circuits that are individually or collectively configured to: (a) calculate an average voltage value from voltages of a first phase and a second phase of the multiphase grid system; (b) determine at least (1) a first voltage difference between the average voltage value and the voltage of the first phase and (2) a second voltage difference between the average voltage value and the voltage of the second phase; (c) produce at least (1) a first real current reference based at least in part on the first voltage difference and (2) a second real current reference based at least in part on the second voltage difference; (d) generate at least (1) a first AC voltage reference based at least in part on the first real current reference and (2) a second AC voltage reference based at least in part on the second real current reference; (e) modulate the first AC voltage reference and the second AC voltage reference to generate a modulated input for a voltage source converter; and (f) use at least the modulated input to provide real current to the multiphase grid system.

In an aspect, disclosed are systems for voltage balancing in a multiphase grid system. A system comprises (a) a component for calculating an average voltage value from voltages of a first phase and a second phase of the multiphase grid system. The system also comprises (b) a first proportional integral (PI) controller and a second PI controller. The first PI controller is configured to determine at least (1) a first voltage difference between the average voltage value and the voltage of the first phase. The second PI controller is configured to determine at least (2) a second voltage difference between the average voltage value and the voltage of the second phase. The first PI controller is configured to provide at least (1) a first real current reference based at least in part on the first voltage difference and wherein the second PI controller is configured to provide at least (2) a second real current reference based at least in part on the second voltage difference. The system also comprises (c) a proportional-resonant (PR) controller for generating at least (1) a first AC voltage reference based at least in part on the first real current reference and (2) a second AC voltage reference based at least in part on the second real current reference. The system also comprises (e) a modulator for modulating the first AC voltage reference and the second AC voltage reference to generate a modulated input for a voltage source converter. The system also comprises (f) a STATCOM comprising the voltage source converter configured to use at least the modulated input to provide real current to the multiphase grid system.

Additional aspects and advantages of the present disclosure will become readily apparent from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The novel features of the present disclosure are set forth with particularity in the appended claims. A better understanding of the features and advantages of the present disclosure will be obtained by reference to the following detailed description that sets forth illustrative embodiments, in which the principles of the present disclosure are utilized, and the accompanying drawings (also “Figure” and “FIG.” herein), of which:

FIG. 1 schematically illustrates a multiphase grid system, in accordance with some embodiments;

FIG. 2 schematically illustrates a control system for a three-phase STATCOM, in accordance with some embodiments;

FIGS. 3A-3C schematically illustrates a phase voltage balancing subsystem with and without a phase current rebalancing feature, in accordance with some embodiments;

FIG. 4 schematically illustrates a voltage magnitude estimator, in accordance with some embodiments;

FIG. 5 schematically shows an example of a DC voltage controller, in accordance with some embodiments;

FIG. 6 shows an example of a droop control sub-system, in accordance with some embodiments;

FIG. 7 shows an example of a current control sub-system, in accordance with some embodiments;

FIG. 8 schematically illustrates results of a voltage balancing implementation, in accordance with some embodiments; and

FIGS. 9-12 illustrate results of various case studies evaluating the performance of the disclosed systems and methods.

### DETAILED DESCRIPTION

While various embodiments of the present disclosure have been shown and described herein, it will be obvious that such embodiments are provided by way of example only. Numerous variations, changes, and substitutions may occur without departing from the present disclosure. It should be understood that various alternatives to the embodiments of the present disclosure described herein may be employed.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

### Overview

The disclosed systems and methods provide a process for correcting voltage unbalance by transferring real power between phases that is implementable by a static synchronous compensator (STATCOM). When other STATCOMs have been used for voltage balancing, their effectiveness has been limited because they may use reactive power (negative sequence) current to attempt to balance voltage.

The disclosed systems and methods can provide voltage balancing, or correct voltage unbalance, in a multiphase grid system. The multiphase grid system may be, for example, a four-wire, three-phase system, where one of the four wires has a neutral connection.

The disclosed systems and methods may provide a process for providing a signal to a STATCOM to balance unbalanced voltages. For instance, the system first may calculate an average of the three phase voltages. Then, the system may compare each of the three phase voltages with the average voltage (e.g., by calculating a difference between the average phase voltage and each phase voltage). The system may then use these voltage differences to determine a real (or active) current reference value for each individual phase. The sum of all real current references may be equal to zero or substantially zero and may not create any active power flow between the direct current (DC) link of the STATCOM and the electricity grid. The system may then use these real current reference values in part to generate AC voltage references. These AC voltage references may be used to generate a modulated input for the STATCOM. Based on the input, the STATCOM may generate currents to the grid that may serve to correct the voltage unbalance.

In embodiments of the present disclosure, the STATCOM may provide both real and reactive current to the grid to correct the voltage unbalance. A control system may provide a modulated input signal to the STATCOM that incorporates both a real current reference that is at least, in part, a product of the voltage balancing process and a reactive current reference that is a product of a droop control system.

Disclosed are methods for correcting voltage unbalance (or voltage balancing) in a multiphase grid system. For example, the system may be a two-phase system or a three-phase system. The system may be a four-wire grid system, where three of the wires correspond to three-phase voltages and the fourth wire corresponds to a neutral connection. The method may be implemented using a control system which provides a signal to a STATCOM for providing real current to the multiphase grid.

In an embodiment, a voltage balancing sub-system within the control system may implement a voltage balancing process. Although the voltage balancing process in this embodiment is described with respect to two phases, it is extendible to balancing any other multiphase grid such as three-phase grid. The voltage balancing sub-system may calculate an average voltage value from voltages of a first phase and a second phase of the multiphase grid system. Calculating the average voltage value from the voltages of the first phase and the second phase may comprise: (i) producing (1) a first individual estimate of the voltage of the first phase and (2) a second individual estimate of the voltage of the second phase; and (ii) calculating a mean of (1) the first individual estimate and (2) the second individual estimate.

The next operation in the process may be determining at least: (1) a first voltage difference between the average voltage value and the voltage of the first phase and (2) a second voltage difference between the average voltage value and the voltage of the second phase. This may be followed by producing at least: (1) a first real current reference based at least in part on the first voltage difference and (2) a second real current reference based at least in part on the second voltage difference. The balancing process may further comprise: (d) generating at least (1) a first AC voltage reference based at least, in part, on the first real current reference and (2) a second AC voltage reference based at least in part on the second real current reference. Also, the balancing process may comprise: (e) modulating the first AC voltage reference and the second AC voltage reference to generate an input to a voltage source converter. This may be done using sine pulse width modulation (PWM) to transform the continuous AC voltage reference signals to a pulse train, enabling switching to occur to generate AC voltage waveforms at the output of the voltage source converter. This may enable (f) the voltage source converter to provide a real current to the multiphase grid system.

One or more circuits may be individually or collectively configured to implement the preceding systems and methods for voltage balancing.

The magnitude estimator may comprise a plurality of quadrature signal generators based on second order generalized integrators (QSG-SOGI). These may be averaged by an averaging component. A proportional-integrator (PI) controller may calculate the real current references for the voltage balancing process. A proportional-resonant (PR) controller may calculate the AC voltage references which are modulated and provided to the STATCOM for voltage balancing.

In (f), the real current may be provided to the multiphase grid system via a STATCOM. The STATCOM may comprise a DC capacitor and the voltage source converter and may provide real current at least, in part, via the voltage balancing process or reactive current via a droop control.

In the voltage balancing process described herein for two phases, the first real current may be negative if the voltage of the first phase is greater than the average value or positive if the voltage of the first phase is less than the average value. Similarly, the second real current may be negative if the voltage of the second phase is greater than the average value or positive if the voltage of the second phase is less than the average value. In the disclosed process, generating the first AC voltage reference and the second AC voltage reference may further comprise summing the first real current reference and the second real current reference with an output current reference from a DC voltage controller.

In the voltage balancing process, generating the first AC voltage reference and the second AC voltage reference may further comprise using a droop controller to produce a first reactive current reference and a second reactive current reference. While the control sub-system may incorporate both droop control and voltage balancing into the signal ultimately provided to the STATCOM, droop control may be implemented simultaneously or separately from the voltage balancing process. Using the droop control may further comprise saturating the first reactive current reference and the second reactive current reference based at least, in part, on the current rating of the voltage source converter, the first real current reference, and the second real current reference. In some cases, the first reactive current reference and the second reactive current reference are based at least in part on the average voltage value calculated from voltages of the first phase and the second phase of the multiphase grid system. In other cases, the first reactive current reference is based at least in part on the voltage of the first phase and the second reactive current reference is based at least in part on the voltage of the second phase.

### Description of the Figures

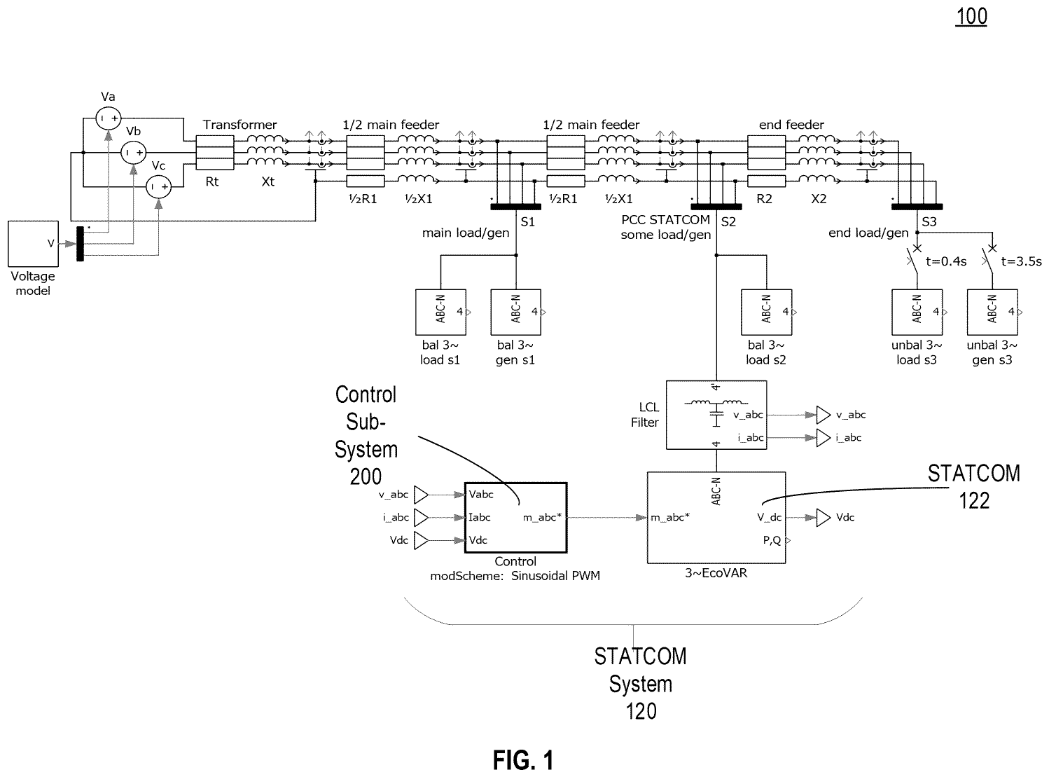

FIG. 1 schematically illustrates a multiphase grid system 100, in accordance with an embodiment. Although the examples show a three-phase grid system, the systems and methods described herein can be applied to any other multiphase grid system. In some embodiments, the three-phase grid system may be a four-wire system. The system may provide a three-phase voltage that may be divided into three individual single-phase voltages that may be provided by three of the wires in the four-wire system. The fourth wire of the system may comprise a neutral connection. The three-phase grid system may include a plurality of generation systems and loads. The loads may be, e.g., residential, commercial, or industrial buildings that require power from the grid. The generation systems may be photovoltaic (PV) generation systems, such as solar PV panels and inverters.

The multiphase grid system may include a STATCOM system 120 to regulate the grid voltage. The STATCOM system 120 may comprise a control system 200 that provides a modulated signal to the STATCOM 122.

Methods and systems disclosed herein can provide unique and improved phase voltage balancing capabilities to a four-wire STATCOM implementation compared to other control schemes such as the synchronous reference frame (e.g., DQ control). In some embodiments, the STATCOM 122 may provide real and reactive current to the multiphase grid responsive to the modulated signal. The STATCOM 122 may be a device that comprises a DC voltage source and a voltage source converter or inverter to convert the DC voltage to AC voltage. The DC voltage source may be a capacitor. The STATCOM 122 may be placed in close proximity to the end (further away from the voltage source) of the grid system, to better regulate voltages where the impedances of the power lines are larger than near the voltage source. The STATCOM 122 may be connected to the point of common coupling (PCC) via an inductor-capacitor-inductor (LCL) filter, which may serve to smooth the output of the STATCOM 122.

In other embodiments, additional loads or generation sources may be added or removed at different locations along the grid.

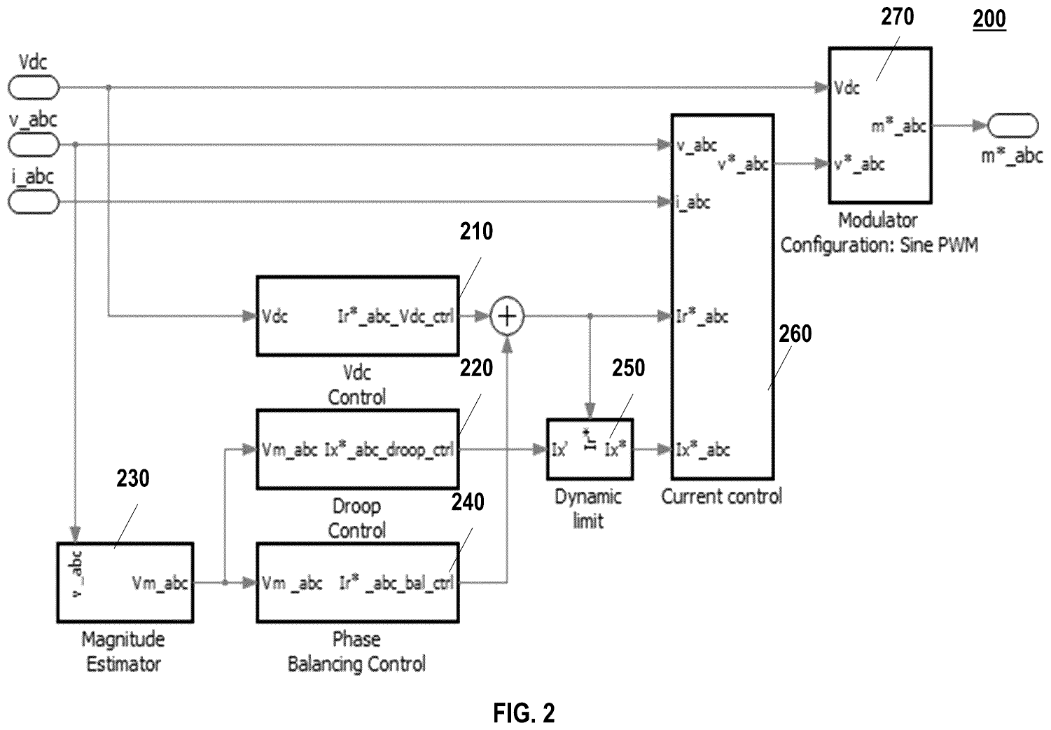

FIG. 2 schematically illustrates a control system 200 for a three-phase STATCOM, in accordance with an embodiment. The control system may include a magnitude estimator 230, a phase balancing control sub-system 240, a droop control sub-system 220, a current limiting sub-system 250, a DC voltage control sub-system 210, a current control sub-system 260, and a modulator sub-system 270. As input, the control system takes each of the three phase voltages (v_abc), each of the three phase currents (i_abc), and a DC link voltage (Vdc), to provide a modulated output (m*_abc).

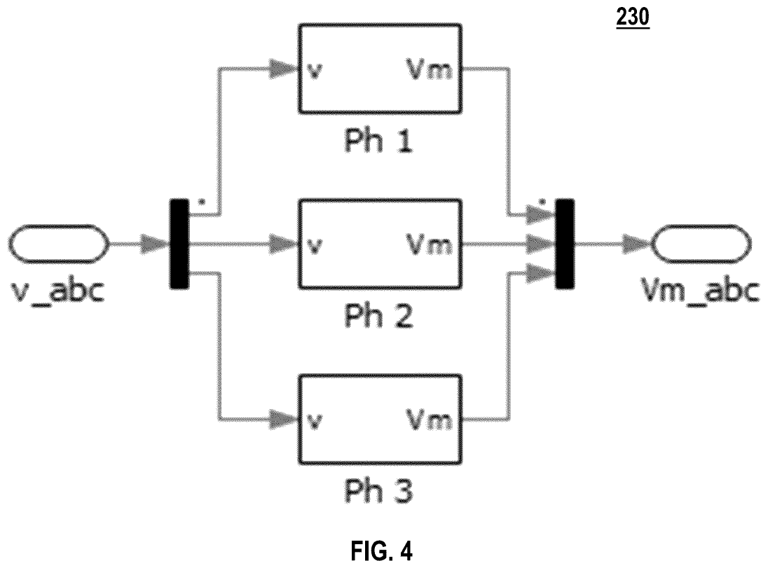

The phase voltage balancing method herein may utilize the magnitude estimation of each phase. For instance, the magnitude estimator 230 of FIG. 2 may estimate the magnitudes of each of the three single-phase voltages individually. FIG. 4 schematically illustrates a voltage magnitude estimator 230. The magnitude estimator 230 may comprise a plurality of quadrature signal generators based on second order generalized integrators (QSG-SOGI) for each individual phase, which may make accurate measurements of the three-phase voltage magnitudes.

The phase balancing control sub-system 240 of FIG. 2 may implement a voltage balancing process to generate real (or active) current reference values to balance the three-phase voltages. The voltage balancing process may correct the voltage unbalance by transferring real power among the three phase voltages.

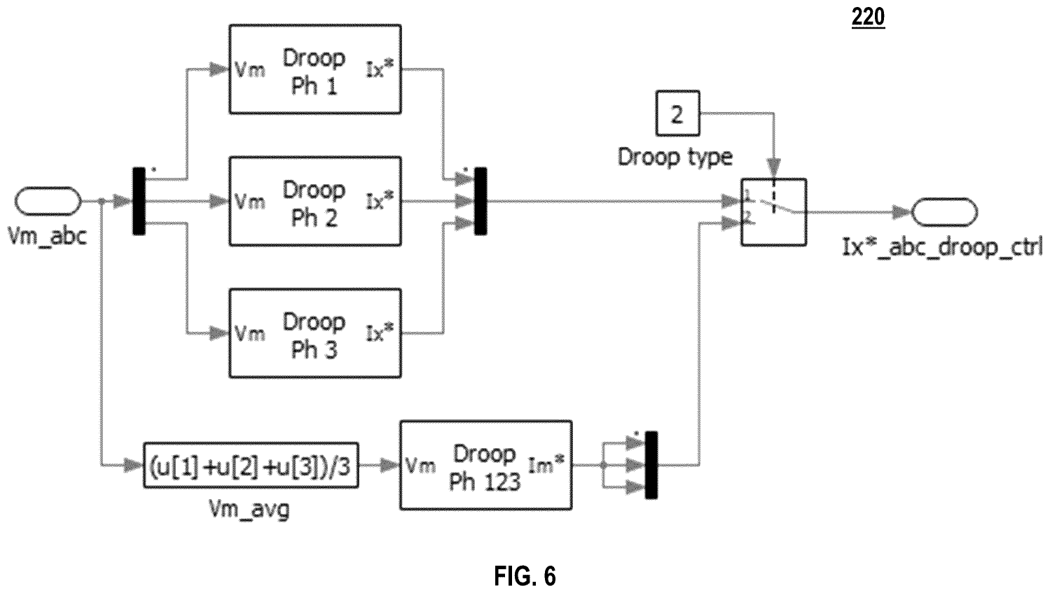

The droop control sub-system 220 of FIG. 2 may enable the STATCOM to control the magnitude of the voltage in the grid, using reactive power control. FIG. 6 shows an example of a droop control sub-system 220. The voltage in the grid may vary with respect to generation (e.g., if solar PV is generating energy) or distance (e.g., the impedance in the line increases further away from the source). If the load on the grid is too great, reducing the voltage level, the droop control may enable the STATCOM to inject positive reactive current, increasing the voltage to prevent it from dropping below a minimum level. If the grid voltage is in danger of increasing above a maximum, (e.g., when solar generation is occurring), the STATCOM may inject negative reactive current to decrease the voltage level.

The droop control sub-system 220 of FIG. 2 may regulate the average value of the three voltage magnitudes based on a reactive power-voltage (Q/V) droop curve and may generate reactive current reference values. These reactive current references may be provided to the current control sub-system along with the real current reference values.

The droop control sub-system 220 of FIG. 2 may be configured to provide multiple types of droop control and may switch between droop control types depending on the grid scenario in which the system operates. FIG. 6 illustrates an embodiment with two types of droop control. A first type, designated as “1”, may provide individual droop control, which, in an example three-phase system, may calculate first, second, and third reactive currents based on first, second, and third phase voltages, respectively. A second type, designated as “2”, may provide global droop control, which may calculate the reactive currents based on the average of the three phase voltages. In the embodiment of FIG. 6, the droop control sub-system 220 selects global droop control. Individual droop control (“1” or Type 1) alone may effectively correct moderate unbalancing in some low-resistance and high-reactance grid scenarios. In other grid scenarios (e.g., high resistance and low/high reactance), global droop control (“2” or Type 2) may outperform individual droop control, when implemented in conjunction with using real power (current) transfer between phases.

The current limiting sub-system 250 of FIG. 2 may limit the magnitude of the reactive current reference produced by the droop control to a rated value (e.g., a value of current which the system is designed to handle). The limiting sub-system 250 may limit the reactive current reference value based on the formula below, where Ix designates a reactive current magnitude and Ir designates a real (or active) current magnitude.

$${I}_{x \_ lim}^{*} = \sqrt{{I}_{rated}^{2} - {I}_{r}^{* 2}}$$

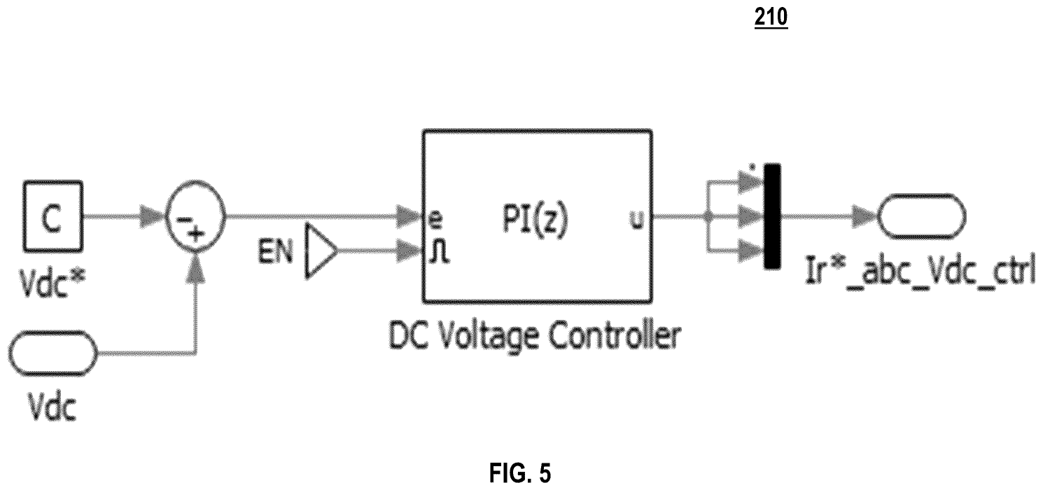

The DC voltage control sub-system 210 of FIG. 2 may provide a signal to regulate the DC voltage of the STATCOM. FIG. 5 schematically shows an example of a DC voltage control. The DC voltage control block may accept as input a DC voltage of the capacitor of the STATCOM and may produce output real current references. In the illustrated example 210, the DC voltage control implements proportional-integral (PI) controller. These current references may be added to the output real current references from the phase balancing control sub-system 240 to produce the real current reference inputs for the current control sub-system 260.

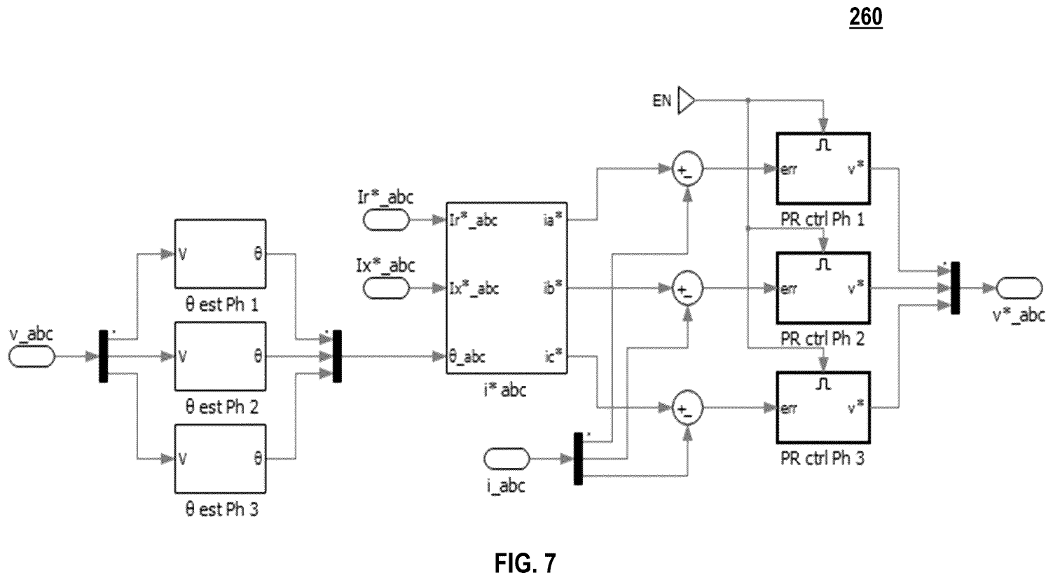

The current control sub-system 260 of FIG. 2 may provide AC converter voltage references, using the three input phase voltages, three input phase currents, real current references calculated by summing the DC link currents and phase balancing current references, and reactive current references provided by the droop control sub-system 220 and limited by the current limiting sub-system 250. FIG. 7 shows an example of a current control scheme implemented by the current control sub-system 260. In the illustrated example, the current control may utilize an individual proportional-resonant (PR) controller for each phase. Each PR controller may also include an individual voltage phase estimator. The PR controller may calculate an AC voltage reference for each phase and the multiple AC voltage references are modulated and provided to the STATCOM for voltage balancing.

The modulator sub-system 270 of FIG. 2 may accept as input the DC capacitor voltage of the STATCOM and the AC voltage references produced by the current control sub-system 260 to produce a set of modulated indices for a voltage source converter of the STATCOM, to enable the STATCOM to provide real (active) (originating at least in part from the voltage balancing sub-system 240) and reactive currents (originating from the droop control sub-system 220) to the three-phase grid, to perform voltage balancing. These AC voltage references may comprise a continuous signal that can be converted to switched values to be usable by the inverter. The modulator sub-system 270 may use sine PWM to convert the continuous signal into a pulse train that emulates the continuous value. The pulse train may provide instructions for the inverter to toggle switching devices on or off, generating AC voltage waveforms at the output of the voltage source converter.

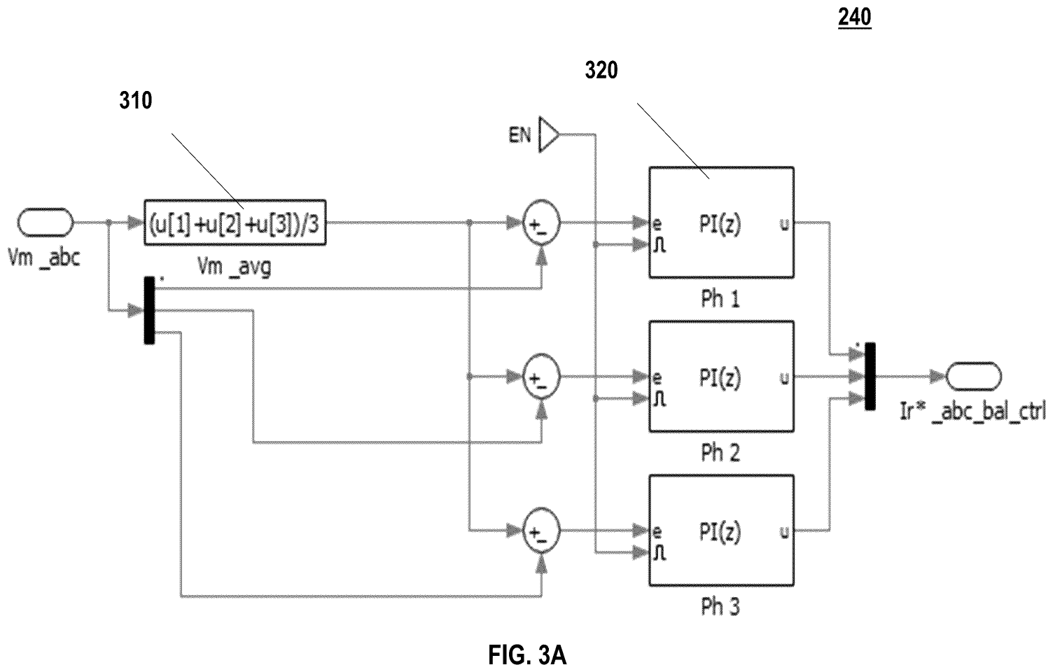

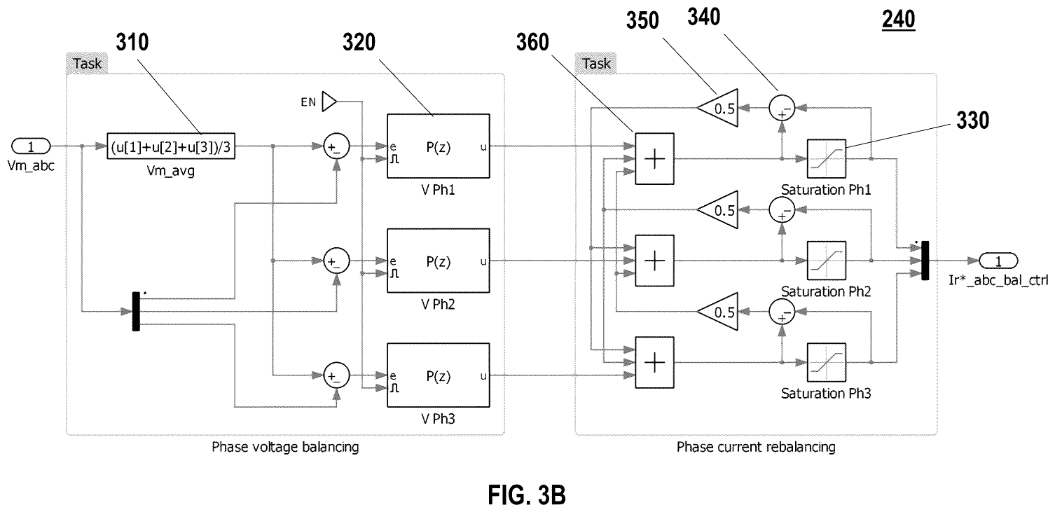

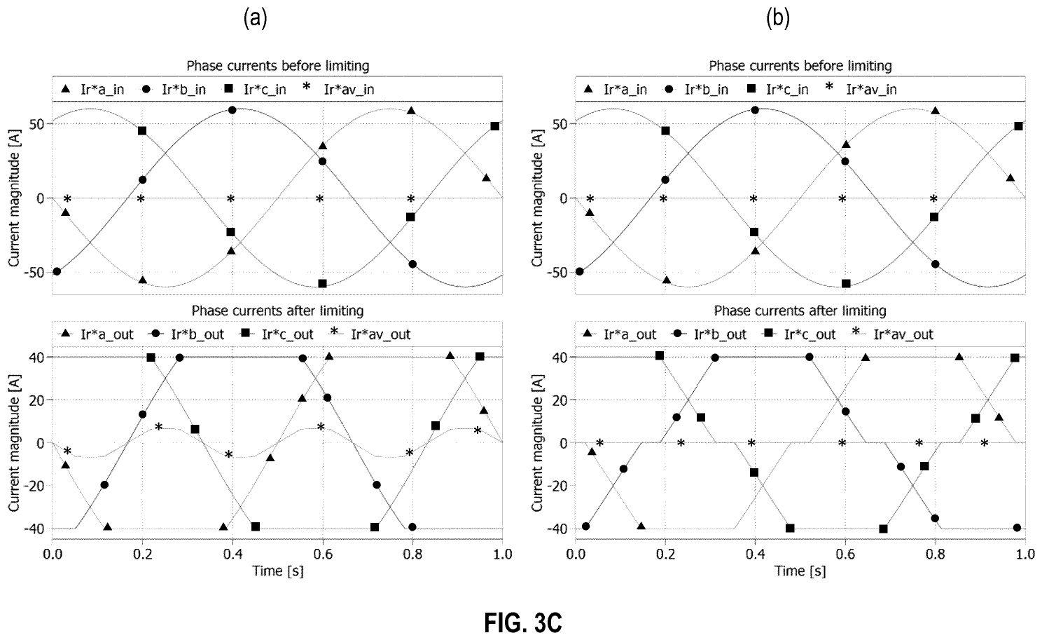

FIG. 3A schematically illustrates an embodiment of the phase voltage balancing subsystem 240 of FIG. 2, in accordance with an embodiment. First, the system may estimate the magnitude of each phase voltage individually, rather than measuring the average voltage of the three-phase system. An averaging system 310 may compute the mean of the three-phase voltages once the system has estimated them. Then, a plurality of proportional-integral (PI) controllers 320 may determine the differences between the mean of the phase voltages and each of the phase voltages. These differences may be used to generate active reference currents. A reference current corresponding to a particular phase may be positive if the difference between the average and the phase voltage is positive. A reference current may be negative if the difference between the average and the phase voltage is negative. The average of the three reference currents may be zero. Therefore, the phase balancing system 240 may not require any real power from the grid or form a DC power source (e.g., a battery system) to perform the voltage balancing.

In another embodiment of phase voltage balancing, phase voltage balancing subsystem 240 may be improved when the average of active phase current references is in equilibrium, e.g., about zero. A problem can arise when an active phase current reference exceeds its associated threshold or limit, wherein, the active phase current reference is confined to its associated threshold. The cumulative sum of active phase current references may no longer be in equilibrium. To solve this technical problem, the present disclosure provides a phase current rebalancing feature as illustrated in FIG. 3B. Phase current rebalancing utilizes as inputs the active phase current references generated by the phase voltage balancing as illustrated in FIG. 3A. In instances where any Saturation block 330 restricts any of these active phase reference currents to their associated thresholds, the difference, determined by block 340, between the unrestricted and limited values (input and output of each Saturation block, respectively) is reduced by half using block 350. This value is subsequently augmented to the remaining two-phase active phase reference currents using blocks 360 prior to reaching Saturation blocks 330. This procedure generates the equilibrium, e.g., the collective sum of active phase current references continues to be about zero. Importantly, this phase current rebalancing approach can extend to a plurality of scenarios, e.g., instances wherein one, two, or all active current references are limited to their associated thresholds.

FIG. 3C demonstrates the utility of the phase current rebalancing feature to improve phase voltage balancing. To illustrate, all active phase reference currents were generated as sine waves that exceeded each associated threshold of 40 A. The active phase current references are depicted both prior to and after Saturation blocks 330. FIG. 3C subpanel (a) occurs when the phase current rebalancing feature is disabled while subpanel (b) occurs when the phase current rebalancing feature is enabled. As illustrated, when the phase current rebalancing feature is enabled, the average of the active phase current references maintains equilibrium or about zero, thereby, improving operation of phase voltage balancing.

Although the disclosed embodiment illustrates the voltage balancing process applied to a three-phase system, a similar process may be applied to correct voltage unbalance for a two-phase system. Such a system may estimate magnitudes of each of the two-phase voltages, compare these magnitudes to the average of the two-phase voltages to produce two real (or active) current reference values.

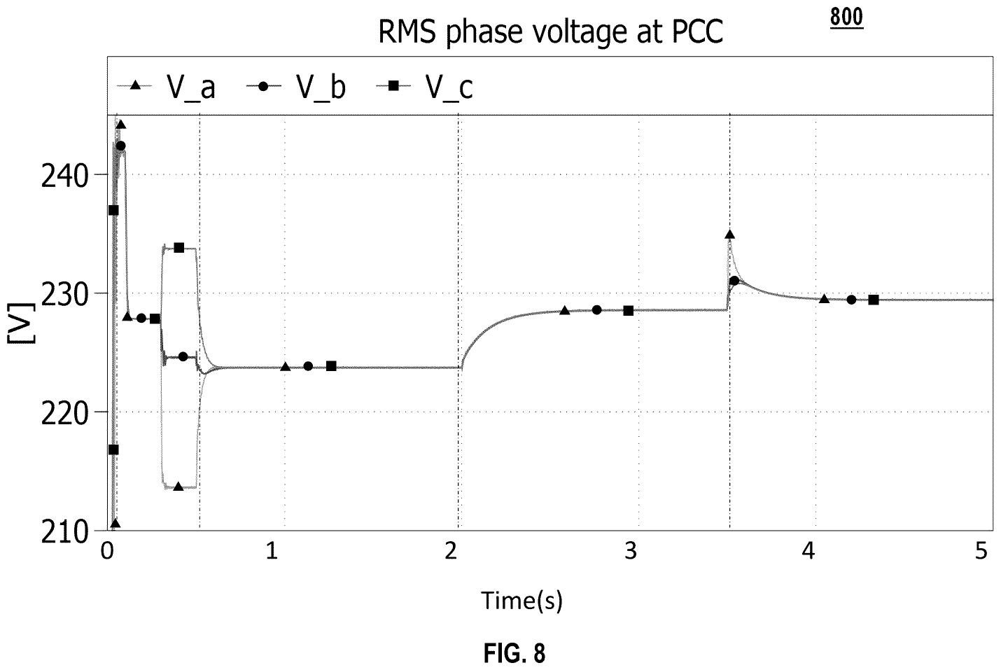

FIG. 8 schematically illustrates a plot 800 of three-phase root-mean-square (RMS) voltages at the PCC during a voltage balancing implementation in accordance with an embodiment. The results illustrate RMS values of AC voltages for each of the three phases: (1) when an unbalanced load is connected, (2) when the STATCOM is connected and engages a voltage balancing process, (3) when the STATCOM engages a droop control, and (4) when an unbalanced generator is connected. In this embodiment, the unbalanced load is connected at about 0.3 seconds, producing a large voltage imbalance among the three phases. At about 0.5 seconds, the STATCOM is engaged and the voltage balancing algorithm injects real current into the multiphase grid, balancing the three-phase voltage. At about 2 seconds, the droop control from the STATCOM, injects reactive power into the multiphase grid, bringing the voltages closer to the set point (e.g., 230V). At about 3.5 seconds, an unbalanced generator is added to further test the balancing algorithm.

Before the STATCOM is turned on, a first phase is at about 213 V, a second phase is at about 224 V, and a third phase is at about 234 V. When the phase voltage balancing is enabled, the unbalance disappears completely. All RMS voltage values approach the average value. The average voltage value approaches the reference value of about 230V when the droop control is enabled at about 2 seconds.

### Case Studies

The following are a set of results from simulations conducted to demonstrate the effectiveness of the voltage balancing process disclosed herein. The results detailed below should not be construed to limit any preceding disclosure.

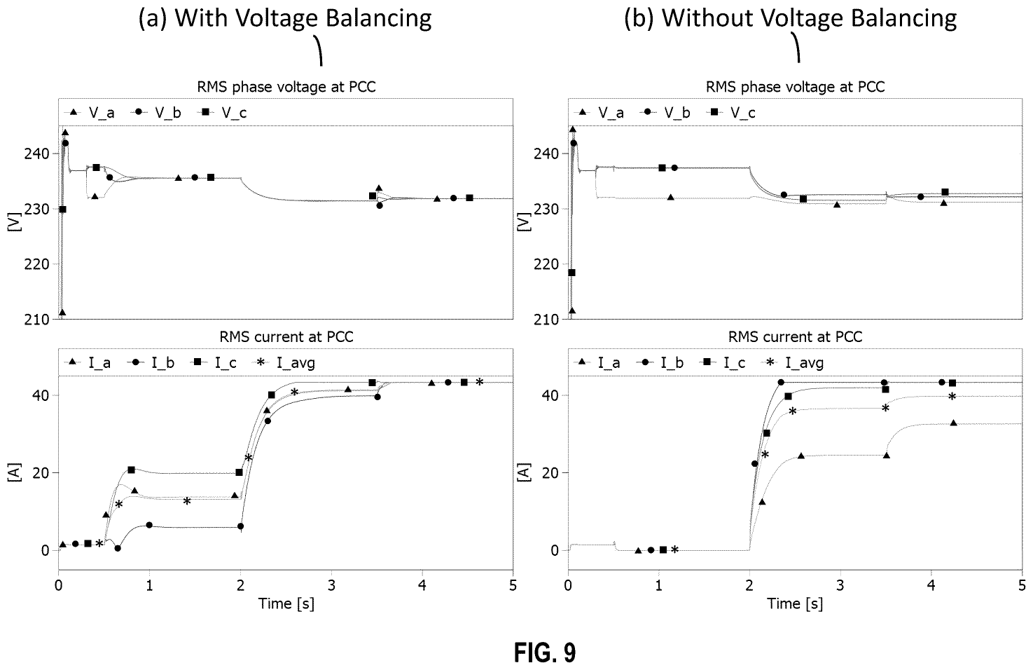

FIGS. 9-12 illustrate results from two different case studies (1 and 2) that were simulated. Each case study was performed using a different type of conductor for the distribution network in the study. In each case study, use of the phase balancing process was compared against not using phase balancing.

The following common settings have been used for the two case studies:

### Grid Model:

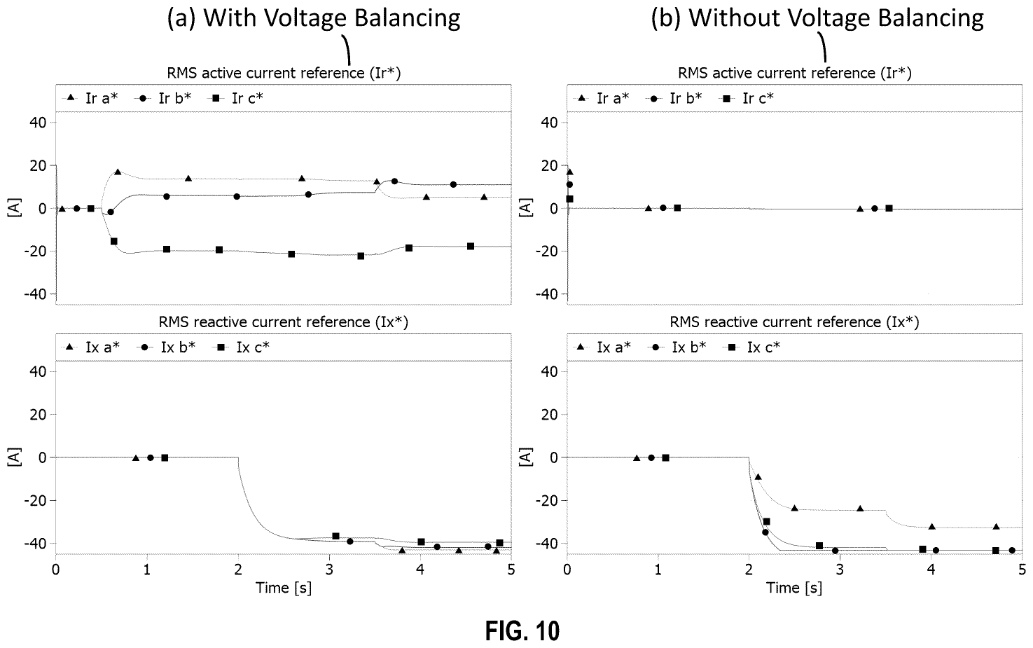

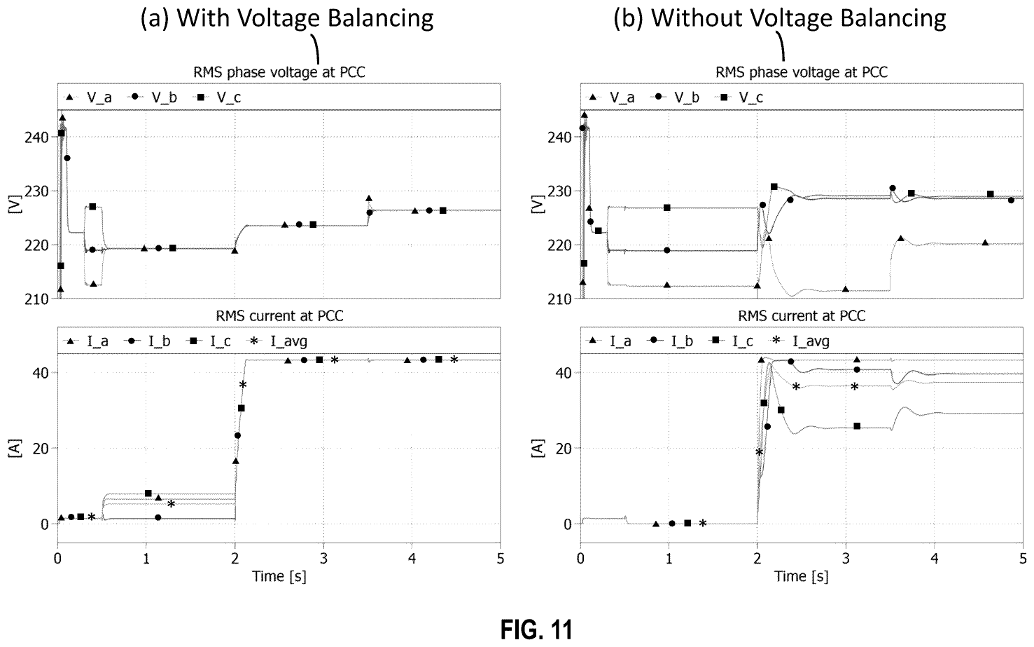

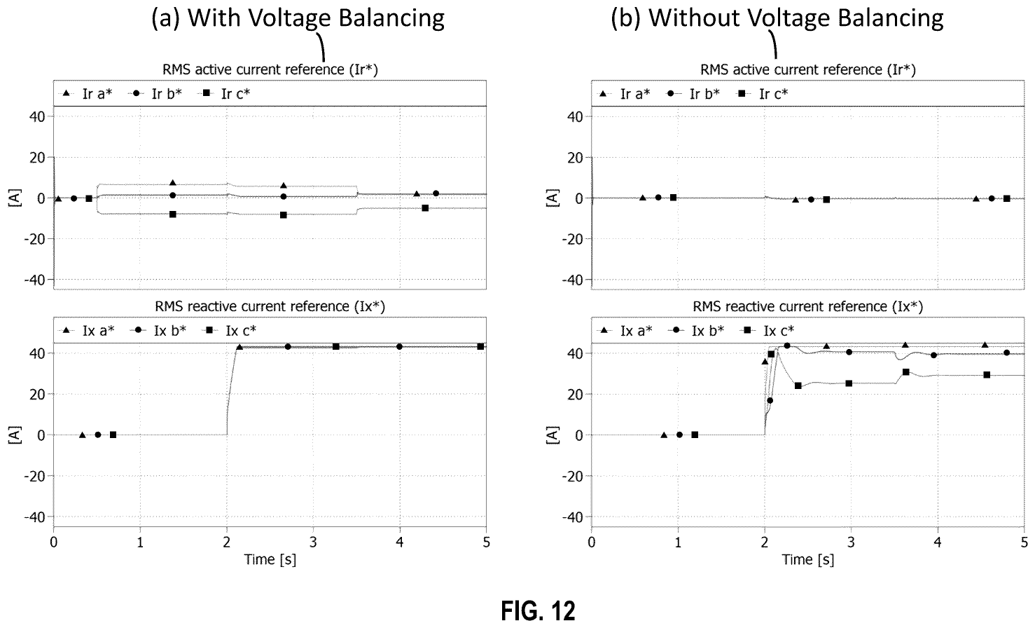

100 kVA transformer (Rt=1.53 Ω, Xt=3.55 Ω)
All feeders were overhead wires
Main feeder length (275 m), end feeder length (100 m)
Conductor types:
   Case Study 1 (FIGS. 9-10): (R1=R2=0.16 Ω/km, X1=X2=0.31 Ω/Km), R/X=0.516
   Case Study 2 (FIGS. 11-12): (R1=R2=1.40 Ω/km, X1=X2=0.40 Ω/Km), R/X=3.500

### Loads/Generators:

All balanced loads/generators were connected to sections S1 and S2 respectively at time t=0.1 seconds
An unbalanced load (100% unbalance between phases) was connected in close proximity to the end of the three-phase feeder at simulation time t=0.3 seconds.
   10 kVA for Case Study 1 (FIGS. 9-10)
   5 kVA for Case Study 2 (FIGS. 11-12)
An unbalanced generator (10 kVA, 50% unbalance between phases) was connected in close proximity to the end of the three-phase feeder at simulation time t=3.5 seconds.
   10 kVA for Case Study 1 (FIGS. 9-10)
   5 kVA for Case Study 2 (FIGS. 11-12)

### Control:

STATCOM was started at time t=0.5 seconds
Voltage balancing was enabled at time t=0.5 seconds for Case Studies 1-2(a)
   Voltage balancing was not enabled for Case Studies 1-2(b)
Droop control was enabled at time t=2 seconds for Case Studies 1-2
   Average droop control per three-phase voltage system was used for Case Studies 1-2(a)
   Individual droop control per phase was used for Case Studies 1-2(b)

The improvement in voltage (reduction in voltage unbalance) can be seen in both case studies (a) when the voltage balancing algorithm is enabled at time t=0.5 seconds. The improvement is more dramatic in case study 2, when the reactive current references generated by the droop control saturates due to reaching rated current limit. This situation may be found in weak distribution grids with a high resistance to reactance (R/X) ratio, a typical grid scenario which may require STATCOM voltage support.

Additionally, when the voltage balancing and the average droop control is enabled (case studies 1-2(a)), the phase currents also become more balanced when compared to other individual droop control per phase (case studies 1-2(b)). This can maximize the available rating of the STATCOM.

What is claimed is:

1. A method for voltage balancing in a multiphase grid system, comprising:
(a) calculating an average voltage value from voltages of a first phase and a second phase of said multiphase grid system;
(b) determining at least (1) a first voltage difference between said average voltage value and said voltage of said first phase and (2) a second voltage difference between said average voltage value and said voltage of said second phase;
(c) producing at least (1) a first real current reference based at least in part on said first voltage difference and (2) a second real current reference based at least in part on said second voltage difference;
(d) generating at least (1) a first alternating current (AC) voltage reference based at least in part on said first real current reference and (2) a second AC voltage reference based at least in part on said second real current reference;
(e) modulating said first AC voltage reference and said second AC voltage reference to generate an input to a voltage source converter; and
(f) using said voltage source converter to provide a real current to said multiphase grid system.

2. The method of claim 1, wherein (c) further comprises generating an equilibrium level of the first real current reference or the second real current reference.

3. The method of claim 2, wherein the generating comprises (i) augmenting the first real current reference with a portion of the second real current reference or (ii) augmenting the second real current reference with a portion of the first real current reference, based at least on the equilibrium level.

4. The method of claim 2, wherein the equilibrium level comprises a sum of the first real current reference and the second real current reference.

5. The method of claim 2, wherein the equilibrium level comprises a level of about zero.

6. The method of claim 1, wherein in (f) said real current is provided to said multiphase grid system via a static synchronous compensator (STATCOM).

7. The method of claim 1, wherein said first real current is negative if said voltage of said first phase is greater than said average value or positive if said voltage of said first phase is less than said average value.

8. The method of claim 1, wherein said second real current is negative if said voltage of said second phase is greater than said average value or positive if said voltage of said second phase is less than said average value.

9. The method of claim 1, wherein generating said first AC voltage reference and said second AC voltage reference further comprises summing said first real current reference and said second real current reference with an output current reference from a direct current (DC) voltage controller.

10. The method of claim 1, wherein generating said first AC voltage reference and said second AC voltage reference further comprises using a droop controller to produce a first reactive current reference and a second reactive current reference.

11. The method of claim 6, wherein said droop controller is configured to provide (1) individual droop control or (2) global droop control, wherein, for (1) said individual droop control, said first reactive current reference is based at least in part on said voltage of said first phase and said second reactive current reference is based at least in part on said voltage of said second phase, and wherein for (2) said global droop control, said first reactive current reference and said second reactive current reference are based at least in part on said average voltage value.

12. The method of claim 7, wherein using said droop controller further comprises saturating said first reactive current reference and said second reactive current reference based at least in part on a current rating of said voltage source converter, said first real current reference, and said second real current reference.

13. The method of claim 1, wherein (a) comprises dividing said multiphase grid system into at least said first phase, said second phase and a third phase.

14. The method of claim 1, wherein said multiphase grid system is a four-wire system.

15. The method of claim 1, wherein said modulating said first AC voltage reference and said second AC voltage reference is performed using sine pulse width modulation (PWM).

16. The method of claim 1, wherein calculating said average voltage value from said voltages of said first phase and said second phase comprises (i) producing (1) a first individual estimate of said voltage of said first phase and (2) a second individual estimate said voltage of said second phase; and (ii) calculating a mean of (1) said first individual estimate and (2) said second individual estimate.

17. A system for voltage balancing in a multiphase grid system, comprising one or more circuits that are individually or collectively configured to:
(a) calculate an average voltage value from voltages of a first phase and a second phase of said multiphase grid system;
(b) determine at least (1) a first voltage difference between said average voltage value and said voltage of said first phase and (2) a second voltage difference between said average voltage value and said voltage of said second phase;
(c) produce at least (1) a first real current reference based at least in part on said first voltage difference and (2) a second real current reference based at least in part on said second voltage difference;
(d) generate at least (1) a first AC voltage reference based at least in part on said first real current reference and (2) a second AC voltage reference based at least in part on said second real current reference;
(e) modulate said first AC voltage reference and said second AC voltage reference to generate a modulated input for a voltage source converter; and
(f) use at least said modulated input to provide real current to said multiphase grid system.

18. The system of claim 17, wherein (c) is further configured to generate an equilibrium level of the first real current reference or the second real current reference.

19. A system for voltage balancing in a multiphase grid system, comprising:
(a) a component for calculating an average voltage value from voltages of a first phase and a second phase of said multiphase grid system;
(b) a first proportional integral (PI) controller and a second PI controller, wherein said first PI controller is configured to determine at least (1) a first voltage difference between said average voltage value and said voltage of said first phase and wherein said second PI controller is configured to determine at least (2) a second voltage difference between said average voltage value and said voltage of said second phase, wherein said first PI controller is configured to provide at least (1) a first real current reference based at least in part on said first voltage difference and wherein said second PI controller is configured to provide at least (2) a second real current reference based at least in part on said second voltage difference;
(c) a proportional-resonant (PR) controller for generating at least (1) a first AC voltage reference based at least in part on said first real current reference and (2) a second AC voltage reference based at least in part on said second real current reference;
(e) a modulator for modulating said first AC voltage reference and said second AC voltage reference to generate a modulated input for a voltage source converter; and
(f) a STATCOM comprising said voltage source converter configured to use at least said modulated input to provide real current to said multiphase grid system.

20. The system of claim 19, further comprising a phase current rebalancing component for generating an equilibrium level of the first real current reference or the second real current reference.
